(19) United States
(12) Patent Application Publication
(10) Pub. No.: US 2010/0064783 A1
(43) Pub. Date: Mar. 18, 2010

(54) DEVICE FOR DETERMINING A MECHANICAL PROPERTY OF A SAMPLE FOR INVESTIGATION

(76) Inventor: Wolfgang Stein, Hueckelhoven (DE)

Correspondence Address: JORDAN AND HAMBURG LLP, 122 EAST 42ND STREET, SUITE 4000, NEW YORK, NY, 10168, US

(21) Appl. No.: 12/451,159

(22) PCT Filed: Apr. 23, 2008
(86) PCT No.: PCT/DE2008/000695

§ 371 Date: Nov. 20, 2009

(30) Foreign Application Priority Data
Apr. 30, 2007 (DE) 10 2007 020 624.2

(51) Int. Cl. G01N 3/42; B23K 26/00

(52) U.S. Cl. 73/81; 219/121.6

(57) ABSTRACT

Provided is a device for determining a mechanical property of a sample to be analyzed, comprising an indenter and means for heating this indenter using laser light. The indenter has an indenter tip at the end directed toward the sample. At least one light guide for conducting the laser light to the indenter, particularly to the indenter tip, is provided as the means for heating this indenter. The aforesaid device relates to an indenter for use in the field of nanotechnology, having an elongated shape, an end region configured as the indenter tip, and means for heating by way of laser light. The indenter may comprise a light guide which is guided at least partially inside the indenter, the light emission end of which is disposed close to the indenter tip.

The invention relates to a device for determining a mechanical property of a sample to be analyzed.

The growing prevalence of microtechnology and nanotechnology necessitates knowledge of material properties at the respective dimensions. So-called nanoindentation is a method that is increasingly commonly employed for the quantitative measurement of mechanical properties, such as the modulus of elasticity, the fracture toughness, and the hardness of a material. Using the nanoindentation method, also referred to as nanoindentation, it is possible to experimentally determine such variables, for example at the level of very thin layers, or for bulk material, with high lateral resolution. Specifically, a so-called indenter, configured in the manner of a microprobe, is placed on the sample to be analyzed, and this indenter applies a force onto the sample surface as a function of the selected measuring specifications.

The aforementioned material properties are typically measured at room temperature. However, there is also a strong interest in conducting such measurements at other temperatures, particularly at higher temperatures. In this way, it is possible to determine the material properties of very thin layers as a function of the temperature, particularly at high temperatures.

A device comprising an indenter for determining the material properties of samples at temperatures of up to 500° C. is known from “Nano-mechanical measurements at 500° C. For the measurement of hardness, modulus and creep at raised temperatures”, Ben D. Beake and James F. Smith, Phil Mag A, as the state of the art.

Specifically, the device comprises an indenter/pendulum having a tiny diamond probe, which is brought in contact with the sample to be analyzed. The sample is disposed in a heating block, which is surrounded by thermal insulation, and includes a sample holder. So as to counteract the temperature gradient, a heat shield is disposed between the sample and the indenter. This heat shield is intended to prevent thermal instability in the sample, which results from heating only the sample disposed in the sample holder, and not the indenter.

The sensitivity of nanoindentation requires as stable a temperature field as possible. The known device only comprises a sample heater, which disadvantageously has an insufficiently stable temperature field, thus drastically limiting the quality of the measurement or the resolution of the nanoindentation test.

A first reason for this problem in the known device is that the sample is heated over a large surface. Other reasons that come in play are that, with this device and the corresponding measuring method, a fixed indenter tip is used, which comes in contact with the heated sample in an unheated state, at room temperature, thereby causing a temperature gradient at the site of the measurement. This results in the disadvantage of the actual measuring point being cooled. It is also disadvantageous that the indenter tip is produced from a material having good thermal conductivity, such as a diamond tip. This effect additionally promotes the aforementioned disadvantageous cooling. Finally, complete heating of the sample holder limits the maximum achievable temperature for a given heating power. The known device was operated at temperatures of up to 500° C. As a result, the accuracy of measurements conducted with this known device for determining the properties of the sample material are disadvantageously impaired. Furthermore, a comparatively high heating power is required to heat the entire sample holder. As a result, the maximum achievable measurement temperature is severely limited.

The objects of the invention are to provide a device and an indenter, having higher measurement accuracy, for determining the material properties of a sample.

One of the objects is achieved by a device according to claim 1. Further embodiments are described in the subsequent claims that reference this claim.

Another object is achieved by an indenter according to claim 18. Further embodiments are described in the subsequent claims that reference this claim.

In order to solve the problem at hand, the device according to the invention comprises means for heating the indenter or the indenter tip by laser.

It was found, as part of the invention, that due to the extremely high energy density of laser heating, which can nonetheless be controlled over a wide range, the site to which energy is supplied is variable and can be matched to the geometry of the indenter provided on the device according to the invention, or can be adapted to the geometry of the indenter tip. In this way, the energy transfer surface is minimized. It was furthermore found that this minimization significantly reduces, or even completely prevents, the temperature-related drift known in the prior art, and consequently the accuracy of the measurement for determining the mechanical property is increased.

Moreover, this laser heater according to the invention, which provides heat to a small area in a nearly punctiform manner, also referred to as a tip heater, can be operated with laser power, which is low in comparison with the heating systems used in the prior art. Thus, a very small size is advantageously achieved for the device according to the invention. Additional measures, such as heat shields and the like, can therefore be omitted.

In a further embodiment of the invention, the device according to the invention may comprise a light guide, which guides the laser light to the indenter, and particularly to the indenter tip. In this way, specific heat storage is advantageously achieved at the site intended for heating. In order to render the guidance of the light more precise, the end of the light guide can be disposed at the indenter or close to the indenter. The end of the light guide may comprise a lens for improved focusing. The arrangement of the end of the light guide can be outside the indenter, so that the heating by laser radiation takes place on the outside of the indenter. From a design point of view, heating can then take place in a stationary manner from the outside, decoupled from potential movements of the indenter according to the invention, which are to be carried out as part of the measurements.

In a further advantageous embodiment of the device according to the invention, the light guide runs inside the indenter, so that the light emission end is guided to the indenter tip inside the indenter. In this way, the laser heater becomes an integrated part of the indenter.

In addition, it is conceivable that the laser heater provided on the device according to the invention comprises not just a first light guide, but one or more additional light guides. In this way, the local site at which the conducted heat is deposited can be suited to the design of the device according to the invention.

In a further embodiment of the invention, the device comprises a sample holder, which is provided for accommodating the sample to be analyzed. For this purpose, the sample can be firmly connected to the sample holder. The sample is preferably connected by an adhesive. In a particularly advantageous embodiment, an adhesive having high thermal conductivity is selected.

The sample holder can preferably be configured so as to be thermally insulating, so that a further increase in temperature stability is achieved. In an advantageous embodiment, the sample holder additionally has high rigidity and low thermal expansion.

In a particular embodiment of the device according to the invention, a material that is transparent with respect to the laser light of the laser heater can be selected as the material for producing the sample holder. Preferably quartz and sapphire materials can be used. This material for producing the sample holder is advantageously optically transparent. In addition, this material exhibits good properties in terms of insulation, rigidity, and thermal expansion. The device can be mechanically optimized so that temperature-related expansion affects only the sample, and not the holder. In a further embodiment of the invention, the sample surface can be configured to be thermally and mechanically stable, thus avoiding temperature-related expansion of the surface and drifting of the surface. For this purpose, the sample can be held directly over the surface to be measured, ensuring that the thermal expansion does not take place in the direction of the indenter tip.

As part of the invention, the temperature can be controlled by way of a thermocouple or a PT-100 element.

One or more of the measures proposed above for laser heating, and the corresponding advantages, can also be employed in further embodiments of the device according to the invention for the laser heating of the sample or samples to be analyzed, to the extent that the device according to the invention is designed to accommodate several samples.

Insofar as a defined temperature of the sample or the indenter is to be set by way of laser heating, PT-100 elements or thermocouples can be used, for example.

In an alternative embodiment of the invention, however, an optional integrated pyrometer can also very advantageously be used for the optical temperature determination of the indenter. The pyrometer can be disposed directly in the beam path of the laser. By using a pyrometer, or if necessary a plurality of pyrometers, the temperature can be determined quickly, and in an advantageous embodiment, a desired temperature, or a desired time-dependent temperature curve, can be set by way of a controller.

Furthermore, it is conceivable that the pyrometer be read by way of a real-time processor, preferably having a frequency of up to 20 kHz. Such a device according to the invention has the advantage of allowing very fast controllers having control frequencies of up to 10 kHz to be used. It was found that by using such a device according to the invention, it is possible to achieve a very fast temperature change in the sample to be analyzed, for example from 50° C./second up to 800° C./second, and particularly in the range of 500° C./second to 700° C./second. Thus, such a device according to the invention opens up entirely new dynamic possibilities. For example, several measurements of the sample can be conducted very quickly at drastically different temperatures. At the same time, the high measuring accuracies required for determining the properties of the sample are achieved.

In a further embodiment of the invention, the indenter can be irradiated at the back (the side facing away from the sample) by means of laser light and thereby heated. The laser light is focused, for example, directly on the indenter by way of an optical fiber. Alternatively, however, the laser light can also provide indirect heating by being aimed at the indenter holder. In all cases, and even with this type of heating, the heat transfer surface is advantageously very small, and as a result the associated advantages of good temperature stability and minimal drift of the device according to the invention are achieved.

In a particularly advantageous embodiment of the device according to the invention, the temperature control of the indenter is corrected to the settable sample temperature, so that no temperature gradient develops in the contact zone between the indenter and the sample, thus completely avoiding associated interference influencing the measurement. In this way, the measurements can be carried out with extremely high accuracy using the device according to the invention.

The device according to the invention can be used for determining a wide variety of material properties of a sample. For example, as a function of the temperature, the penetration depth of the indenter can be determined, and the hardness or modulus of elasticity of the material of a thin layer or a thin film can be determined. It is also possible to perform scratch tests or frictional force measurements with high measurement accuracy.

Having knowledge of these mechanical properties of such thin layers plays an important role in so much as such materials, for example when used in electronic components, are at times subject to considerably higher temperatures than room temperature during operation, and depending on the selection of the material used, the mechanical properties of these layers are highly temperature-dependent. By having improved knowledge of these material properties, the device according to the invention also allows the quality of a tool or electronic component comprising one or more such thin layers to be improved by appropriately selecting the layer material.

The device according to the invention can also be used for measuring the dynamic hardness of thin layers or films. For example, when cutting metal using coated tools, having knowledge of the dynamic, material properties is crucial for the selection of a suitable coating for such a tool.

The use of the device according to the invention also plays an important role when it comes to wear-resistant tools to produce such layers, because during such friction and wear processes considerable heat is developed, and the selected layer must therefore also exhibit suitable material properties at high application temperatures.

The object is further achieved by an indenter according to the invention having the characteristics according to claim 18. Further advantageous embodiments are described in the claims dependant on this claim.

The invention will be explained below in more detail based on several examples and figures. Shown are:

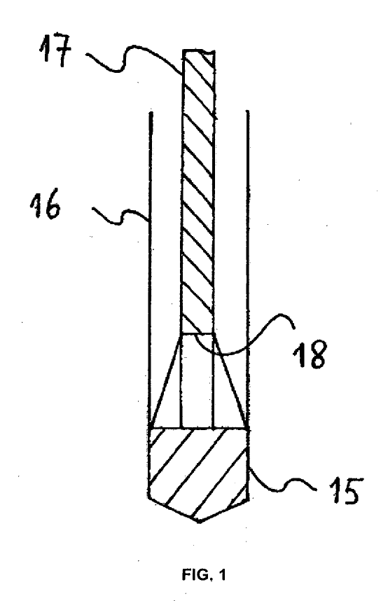

FIG. 1 a cross-sectional view of a first embodiment of the indenter according to the invention, comprising an internally disposed heater for heating;

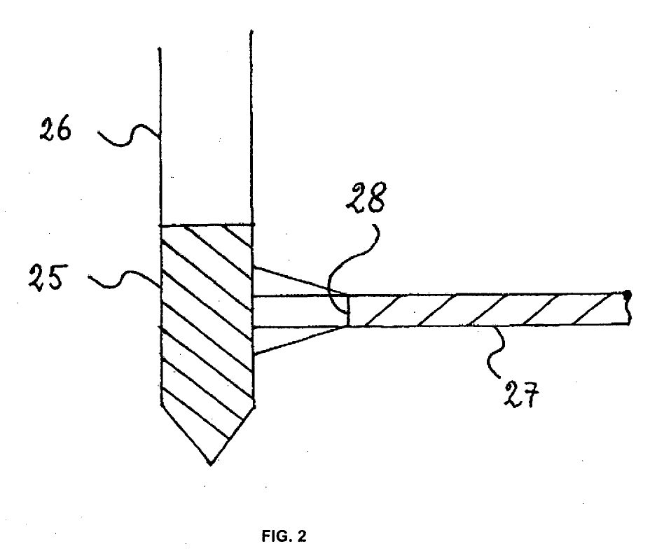

FIG. 2 a cross-sectional view of a second embodiment of the indenter according to the invention, comprising a heater, disposed to the side of the indenter tip, for heating;

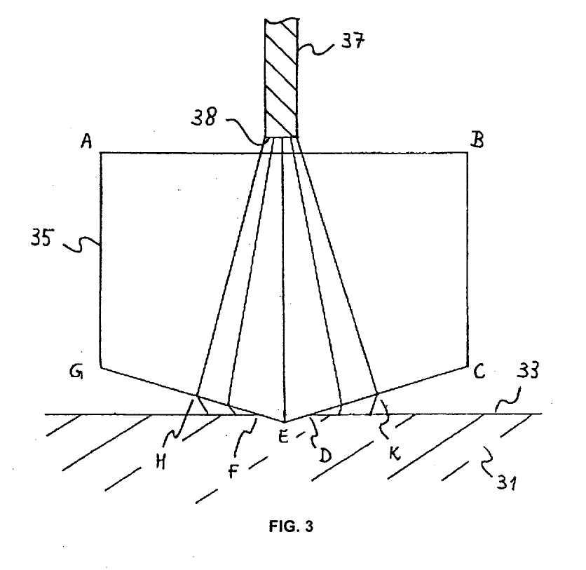

FIG. 3 a cross-sectional view of an indenter tip according to the invention in a third embodiment of the indenter according to the invention, comprising an internally disposed heater for heating, a tip material that is transparent with respect to the wavelength of the laser light has been selected.

With reference to the embodiments below, the device according to the invention comprises a sample to be analyzed, the sample being connected to a sample holder. For contact formation, the indenter tip of an indenter according to the invention is connected to the device according to the invention and disposed on the free sample surface of the sample. Such a device according to the invention may comprise one or more laser heating systems, which are described in detail below.

FIG. 1 shows a first embodiment of an indenter 16 comprising an indenter tip 15 for a device according to the invention. Specifically, the end of a partially illustrated indenter 15, 16 is shown, comprising a pointed region, the pointed end of which can be brought in contact with the surface of a sample to be analyzed. This end has a pointed shape for substantially punctiform contact with the sample surface. This end region of the indenter 16 is referred to hereinafter as the tip 15 or indenter tip 15. This indenter tip 15 is shown in a cross-sectional view and hatched in FIG. 1.

For laser heating according to FIG. 1, the indenter 16 comprises a light guide 17 (glass fiber 17), shown hatched, which projects into the indenter 16, starting from the side of the indenter 16 facing away from the sample, and is only partially shown in FIG. 1. The end 18 of this light guide 17 can be configured with or without a lens for focusing the laser light guided by the light guide 17 onto the indenter tip 15. Without a lens, the embodiment has a simpler design, which can be used for heating the indenter tip 15. If the device according to the invention comprises a lens provided at the end 18 of the light guide 17, a further increase in the focusing of the laser light favoring local heating can be achieved. In order to represent a possible beam path, four lines are drawn in FIG. 1, which connect the end of the light guide 18 to the tip 15. In this way, laser light can be applied to a larger or smaller part of the tip surface facing the light guide inside the indenter 16, depending on the focusing.

Alternatively, in a second embodiment according to FIG. 2, the indenter 26 according to the invention for producing a device according to the invention comprises a heating means, which guides the laser light laterally to the indenter tip 25. In this way, a heater that is not necessarily connected to the indenter is proposed. Without limiting the general idea of the invention, for this purpose, in the second embodiment, a light guide 27 is likewise provided, the end 28 of which is disposed close to, but at a distance from, the indenter tip 25, a cross-sectional view of which being shown in a hatched manner. The end 28 of the light guide 27, which is only partially shown in a hatched manner, in a cross-sectional view, can also comprise a lens for focusing the emitted laser light. Also, with respect to the movements performed by the indenter tip 25, a light guide 27, 28 provided with a lens, ensures improved orientation of the emitted light on the outside of the indenter tip 25. In order to represent a possible beam path, four lines are also drawn in FIG. 2, which connect the end of the light guide 28 to the outer circumference of the tip 25. Thus, depending on the focusing, laser light can be applied to a larger or smaller part of the tip surface facing the light guide outside the indenter 26.

Within the context of the invention, it is conceivable that two alternative embodiments be used at the same time. In this way, the possible deposition of heating energy is increased, and a higher application temperature can be achieved. Of course it is also conceivable to dispose a plurality of light guides around the outside of the indenter tip in order to heat the indenter.

When heating the indenter according to the invention, measurement of the set tip temperature is highly important. It is conceivable that a device according to the invention, comprising an indenter according to FIG. 1 or 2, has a pyrometer for optical temperature measurement. Alternatively, it is also possible to measure the temperature by way of a thermocouple or resistance thermometer. As with the laser heating of the indenter tip, this temperature measurement can selectively be performed outside the indenter, oriented towards the outside thereof. Means for temperature measurement, however, may also be disposed on the inside of the indenter, starting from the side of the indenter that faces away from the sample and extending into the indenter.

From a design point of view, such a configuration is relatively easy to implement. The indenter according to the invention, for example, has a diameter of 3 millimeters to less than 1 millimeter. The light guide used for laser heating, for example, has a diameter of only 0.1 millimeters. As a result, sufficient interior space remains in a device according to the invention comprising an indenter according to FIG. 1 or 2 to achieve, for example, an optical temperature measurement with the aid of a further light guide on the inside of the indenter according to the invention.

Many variants are conceivable for controlling the temperature and/or heating power of the device according to the invention. The use of a thermocouple or resistance thermometer is a relatively sluggish measuring method in terms of time. Faster temperature measurements can be achieved by using a pyrometer. To this end, in the context of the invention, the pyrometer can be disposed directly in the beam path of the laser heater, using suitable means. A controller for the signal of such a pyrometer can be scanned, for example, at 10 kHz and consequently be read at several kHz, particularly 1 kHz to 8 kHz.

In order to produce a device according to the invention, the indenter according to the invention, as illustrated in FIG. 1 or 2, can be brought into contact with the sample surface, with the indenter tip preferably disposed in the perpendicular direction relative to the surface of the sample to be analyzed.

The device according to the invention can furthermore comprise a sample holder for accommodating a material sample to be analyzed. The sample holder is preferably formed so as to be mechanically rigid. The sample can be clamped into the sample holder. Alternatively, it is conceivable to fasten the sample to the sample holder using a suitable adhesive, and preferably a ceramic adhesive.

In one embodiment of the invention, the device according to the invention may comprise means for producing a sample heater using laser light.

To this end, a light guide can be provided, in which laser light from a laser source is guided to the open end of the light guide. This end can be disposed directly at the back of the sample, facing away from the front provided for contact with the indenter, so that laser light directly heats the back, of the sample to be analyzed. As a matter of course, optical or other temperature measurements can also be used as temperature measurements for this heater, such as in the manner of the optical pyrometer described above in the context of the tip heater, a thermocouple, or a resistance thermometer. In this case also, a light guide can be used for optical temperature measurement.

A particularly advantageous embodiment of the invention relates to a laser heater having optical temperature measurement and temperature control, wherein both the indenter tip and the sample to be analyzed are heated by laser. In this case, the laser heater can be configured using a system comprising a plurality of light guides.

To ensure that the laser light can be guided to the sample, advantageously a sample holder accommodating the sample is used, which preferably comprises a carrier that is transparent with respect to the wavelength of the laser light. Additionally, in this context, when using an adhesive for holding the sample, it is advantageous to select an adhesive that is transparent with respect to the wavelength of the laser light.

A wavelength in the range of the visible to the infrared (IR) region can be used as the wavelength for the light.

In terms of the optical configuration of the device according to the invention for heating and measuring the temperature of the indenter and sample, a controller may be provided such that the pyrometer beam path is coaxially integrated in the laser beam path and decoupled by way of a wavelength-dependent beam splitter.

Very fast temperature control can be achieved as a function of the sample mass or the substrate mass carrying the laminar or film-shaped sample. For example, using the device according to the invention, temperature programs can be run which enable exact, time-dependent temperature ramps of up to several 100° C./second, such as 200° C./second to 700° C./second. This achieves extremely fast and reliable capturing of the measurement results for determining mechanical properties. By using such a rapid heating time, in particular non-equilibrium processes, and notably thermally-induced material changes, can be analyzed.

Using the device according to the invention, temperatures of at least up to 500° C., in particular in the range from 700° C. to 900° C., and preferably from greater than 1000° C. up to the melting temperature of the materials used, can be achieved as a function of the material used for producing the indenter and substrate or sample.

In a coordinated combination of an indenter tip heater with a sample heater and an associated controller, the device according to the invention advantageously prevents distortion of the measurement temperature, and therefore of the measurement results for determining the mechanical properties of the thin sample to be analyzed based on temperature differences between the indenter and sample. In the context of the invention, regulation that is matched to the laser heater and temperature measurement can ensure that the sample and indenter, or indenter tip, both have exactly the same temperature. This ensures optimal evaluation for determining the mechanical property or properties.

In a further embodiment of the invention, it is conceivable that the device according to the invention comprises an indenter tip 35, which is composed of a material that is transparent with respect to the laser wavelength intended for laser heating. This indenter tip 35, being part of an indenter which is not shown specifically, is illustrated in FIG. 3 in the cross-section A, B, C, D, E, F, G. In this way, such a device according to the invention may comprise a light guide 37, indicated in a hatched manner and shown in part in FIG. 3, guiding the laser light to the indenter tip 35, the light guide being guided on the inside of the indenter, which is not illustrated in detail in FIG. 3. If the tip 35 is configured so as to be transparent, this laser light, after exiting the light guide 37 at the end 38 of this light guide 37, will enter the tip 35 and then exit the side of the tip 35 facing the sample surface 33. The tip 35 comes in contact with the surface of the sample 33 shown in a hatched manner in part in FIG. 3. In order to represent a possible beam path, four lines are drawn in FIG. 3, which connect the end of the light guide 38 to the transparent tip 15 and then penetrate it. Further focusing in the direction E can be achieved by way of refraction, at least at the media boundary G, E, C of the tip 35.

In a particularly advantageous manner, by using transparent material to produce the tip 35 for this kind of emission outside the contact surface D, E, F between the tip 35 and sample 31, focusing in the direction of the contact surface D, E, F between the sample 31 and tip 35 is achieved by way of the refractive properties of the light in the direction of the tip E. Accordingly, the heating energy is predetermined and optionally optically focused on the sample region intended for heating and for subsequent measurement of the mechanical property or properties.

The light is absorbed at the site of the contact surface D, E, F between the tip 35 and sample 31. Based on the local optical circumstances, due to the focusing, the sample material located around the contact surface in the regions F, H and D, K is also heated as a result of the refraction.

This targeted focusing and centering on the region of the contact surface between the sample and tip as a result of the selection of a transparent material for producing the indenter tip 35 can be set more specifically when taking the spatial shape of the indenter tip 35 into consideration, particularly insofar as the dimensions, preferably the thickness B, C, width A, B, and angle size of the tip E of the tip 35 are concerned; or relevant specifications can be selected accordingly. The knowledge that these geometries and dimensions of the tip 35 constitute a function of the indenter material is utilized to this end.

With such an embodiment of the device according to the invention, the temperature can be measured using a thermocouple or pyrometer. If the temperature is measured using a thermocouple, corresponding optical devices prevent heating of the thermocouple by the laser, or the laser light, and therefore the temperature of the substrate or sample surface is captured directly. A diode laser or a solid-state laser can be used as the laser.

In order to illustrate a possible beam path, in FIGS. 1, 2, and 3, the respective ends of the light guides disposed at a distance from the tip show four lines, which for illustration purposes are intended to represent emitted light beams. In the context of the invention, the shape of the emitted light beam can be set with or without optical means at the end of the light guide. For example, the beam spot can supply a partial region of the indenter, or the entire indenter surface that can be reached with laser light in the position in question, thereby establishing a desired energy distribution for the heating of the indenter.

In this description, or in the claims below, insofar as the terms indenter or indentor are used, the object according to the invention denoted in this way shall constitute, at least at one end, a point referred to as an indenter tip, or simply a tip, which can be used for producing a force on the sample surface with the device according to the invention for determining a mechanical property of a sample to be analyzed.

The embodiments described based on FIGS. 1 to 3 do not limit the teaching according to the invention. The scope of the invention covers the objects described in the claims below.

1. A device for determining a mechanical property of a sample to be analyzed, comprising an indenter and means for heating the indenter using laser light.

2. A device according to claim 1, wherein the indenter comprises an indenter tip at the an end directed toward the sample.

3. A device according to claim 1, wherein at least one light guide for guiding the laser light to the indenter and particularly to the indenter tip, is provided as the means for heating the indenter by way of laser light.

4. A device according to claim 1, comprising at least one light guide having an end for emitting the laser light, and this end is disposed inside the indenter close to the indenter tip.

5. A device according to claim 1, comprising at least one light guide having an end for emitting the laser light, and this end is disposed outside of the indenter close to the indenter tip.

6. A device according to claim 1, comprising at least one light guide having an end which comprises a lens for focusing the laser light.

7. A device according to claim 1, comprising a sample holder for accommodating at least one sample to be analyzed.

8. A device according to claim 1, comprising means for heating the sample by way of laser light.

9. A device according to claim 8, wherein at least one light guide for guiding the laser light to the sample, and particularly to the back of the sample, is provided as the means for heating the sample by way of laser light.

10. A device according to claim 1, comprising at least one light guide having an end which comprises a lens for focusing the laser light on at least one sample.

11. A device according to claim 1, comprising means for optical temperature measurement.

12. A device according to claim 11, wherein a pyrometer is provided as the means for optical temperature measurement.

13. A device according to claim 12, comprising at least one further light guide is which allows the pyrometer to capture at least the temperature of the sample or indenter and particularly the temperature of an indenter tip.

14. A device according to claim 1, comprising a temperature controller which processes the a signal of at least one pyrometer for controlling the heating power of the sample and/or the indenter.

15. A device according to claim 1, wherein a material which is transparent with respect to the wavelength of the laser light provided for heating is provided for producing an indenter or an indenter tip.

16. A device according to claim 15, wherein a diamond or sapphire is provided as the material for producing an indenter or an indenter tip.

17. A device according to claim 1, comprising a controller which allows the signal of at least one pyrometer to be scanned at a frequency in the range of 1 to 12 kHz, particularly at a frequency of 20 kHz.

18. An indenter for use in the field of nanotechnology, particularly for use in a device according to claim 1 having:
an elongated shape,
an end region configured as an indenter tip, and
means for heating by way of laser light.

19. The indenter according to claim 18, comprising at least one light guide for guiding the laser light as the means for heating by way of laser light.

20. The indenter according to claim 18, comprising a light guide which is guided at least partially inside the indenter and the light emission end of which is disposed close to the indenter tip.

21. A device according to claim 1, wherein at least one laser and optical means, which allow the laser light to be guided to the indenter the indenter tip and/or to the sample, is provided as the means for heating by way of laser light.

22. An indenter according to claim 1, wherein at least one laser and optical means, which allow the laser light to be guided to the indenter, the indenter tip and/or to the sample, is provided as the means for heating by way of laser light.
